(19) United States
(12) Patent Application Publication
(10) Pub. No.: US 2017/0358838 A1
(43) Pub. Date: Dec. 14, 2017

(54) LOAD-ADAPTIVE APERTURE TUNABLE ANTENNA

(71) Applicant: Futurewei Technologies, Inc., Plano, TX (US)

(72) Inventors: Wei Huang, Santa Clara, CA (US); Ping Shi, Santa Clara, CA (US)

(21) Appl. No.: 15/178,491

(22) Filed: Jun. 9, 2016

(51) Int. Cl. H01Q 1/12; H01Q 1/48; H01Q 1/24; H04W 4/00; H01Q 9/04

(52) U.S. Cl. CPC H01Q 1/1257; H04W 4/005; H01Q 9/04; H01Q 1/243; H01Q 1/48

(57) ABSTRACT

Methods, apparatus and systems are provided including a load-adaptive antenna for mobile communication devices. One aspect provides a method of using an antenna within a handheld wireless communication device. The method includes monitoring antenna performance using information received from a sensor within the device. When antenna performance drops below a programmable threshold, such as due to proximity or contact with a user, a signal from a processor is used to actuate a circuit component to change a location of a high impedance portion of the antenna to reduce the effects of the proximity or contact with the user, in various embodiments.

### TECHNICAL FIELD

The present disclosure relates to wireless communication. More specifically, the present disclosure relates to a load-adaptive antenna for wireless communication.

### BACKGROUND

Mobile phone antenna design is increasingly complicated due to carrier and regulatory requirements. In addition, there are multiple antennas on each phone, e.g., main cellular antenna, diversity cellular antenna, global positioning system (GPS) antenna, local internet (Wi-Fi) antenna, and near field communication (NFC) antenna.

Mobile phones with metal cases have grown in popularity. Unlike phones with plastic shells where the antennas are inside of a nonconductive cover which protects a user's hand from direct contact with the antennas, phones with metal covers can have antenna problems when held by the user. When the user's hand covers a gap or slot on the metal cover, the low resistance of the hand can electrically short the slot or gap, and often the antenna performance will significantly degrade which may result in dropped calls or loss of signal. This scenario is commonly referred to as the “death grip.”

Thus, there is a need for improved antenna design for hand-held electronic devices.

### SUMMARY

Methods, apparatus, and systems are provided including a load-adaptive antenna for mobile communication devices. One aspect provides a method of using an antenna within a handheld wireless communication device. The method includes monitoring antenna performance using information received from a sensor within the device. When antenna performance drops below a programmable threshold, such as due to proximity or contact with a user, a signal from a processor is used to actuate a circuit component to change a location of a high impedance portion of the antenna to reduce the effects of the proximity or contact with the user, in various embodiments.

Another aspect provides a handheld wireless communication device including a metal housing, an antenna for wireless communication, a sensor configured to sense a parameter indicative of antenna performance, a circuit component within the housing connected to the antenna at or near a high impedance portion of the antenna, and a processor within the housing. The processor is configured to monitor performance of the antenna using information received from the sensor and when antenna performance drops below a programmable threshold, such as due to proximity or contact with a user, the processor actuates the circuit component to change a location of the high impedance portion of the antenna to reduce the effects of the proximity or contact with the user. In various embodiments, multiple sensors are used.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 illustrates a perspective view of an antenna for a mobile communication device, according to various embodiments.

FIG. 2 illustrates a portion of a mobile communication device including an antenna, according to various embodiments.

FIG. 3 illustrates a top view of a bottom portion of a mobile communication device including an antenna, according to various embodiments.

FIG. 4 illustrates a cross section view of a mobile communication device as held by a human hand in proximity to an antenna, according to various embodiments.

FIG. 5 is a graph illustrating return loss for an antenna of a mobile communication device, according to various embodiments.

FIG. 6 is a graph illustrating total efficiency for an antenna of a mobile communication device, according to various embodiments.

FIGS. 7A-7B illustrate an antenna electric field distribution for a mobile communication device, according to various embodiments

FIG. 8 is a block diagram illustrating circuitry for implementing devices to perform methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical, and electrical changes may be made without departing from the scope of the present invention. The following description of example embodiments is, therefore, not to be taken in a limited sense and the scope of the present invention to be interpreted broadly, as defined by the appended claims.

Mobile communication devices with metal shells, unlike those with plastic shells where the antennas are inside of a nonconductive cover which protects a user's hand from direct contact with the antennas, may have antenna problems when held by the user. When the user's hand covers a gap or slot on the metal cover, commonly referred to as a death grip, the low resistance of the hand can electrically short the slot or gap, and often the antenna performance will significantly degrade (by 12 dB or more) which may result in dropped calls or loss of signal.

The most common way currently used to avoid death grip is antenna switch, which switches from one antenna on the device to another antenna when one antenna efficiency suffers degradation due to hand grip. However, the switch decision is usually made using received signal strength indicator (RSSI) detection or other indication of the signal quality, which causes delay especially in a weak signal area. Also, the insertion loss of the switch itself will reduce operational acceptance testing (OAT) performance regardless of switch state. In a typical configuration of a handset, the bottom antenna is the main antenna and the top antenna is mainly used as diversity antenna. Often when the transmission (Tx) antenna switches to the top part of the phone, specific absorption rate (SAR) of the user's head can be a problem at high frequencies (bands such as. B2, B4, B7, etc.).

Another common way to avoid death grip is to match antenna impedance with a closed-loop impedance tuner. While some mismatch loss is recovered, impedance tuning is not able to recover the significant loss due to the change of the antenna mode. A further common way to avoid death grip is to use a plastic cover over the device such that the user's hand will not be in direct contact with the metal body of the device. While this helps to reduce impact on antenna performance, the plastic cover has a cosmetic impact, and many users would prefer not to use this type of cover.

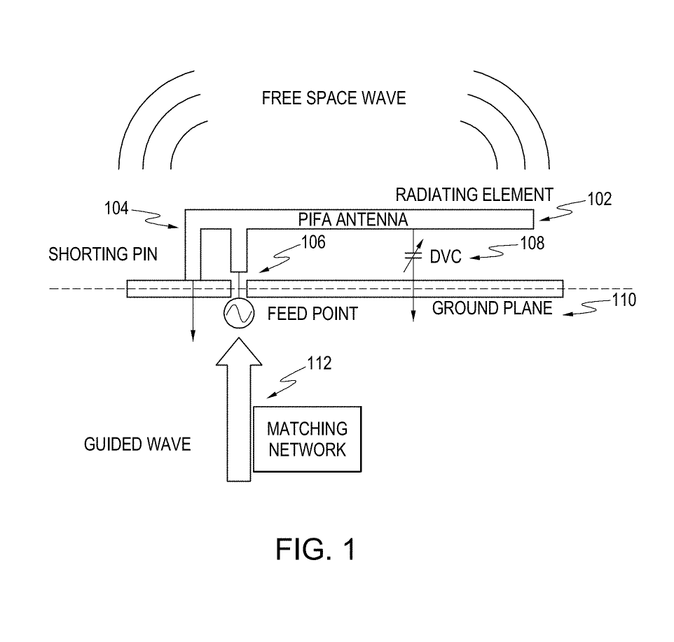

FIG. 1 illustrates a perspective view of an antenna 102 for a mobile communication device, according to various embodiments. The illustrated antenna is a planar inverted-F antenna (PIFA), but other types of antennas may be used without departing from the scope of the present subject matter. The antenna 102 includes a first grounding connection 104 and a portion proximate feed point 106. A digital variable capacitor 108 connects the antenna to ground plane 110, and a matching network 112 interfaces with the antenna at the feed point 106. In the aperture tuned antenna, radiation efficiency can be optimized from the antenna terminals into free space, and the resonant frequency and the radiation pattern can be tuned. However, conventional aperture tuning cannot change the antenna resonant mode.

The present subject matter provides a method of tuning an aperture tunable antenna to adapt to antenna load change, especially the death grip case for which the antenna load has changed the original antenna resonant mode. In various embodiments, the aperture tunable antenna includes switch(es) or tunable capacitor(s), and the state of the switch or tunable capacitor changes as antenna load changes. The switches or tunable capacitors are placed and actuated such that when the human body is placed at an antenna high impedance location, the switch state or tunable capacitance value changes the high impedance location so that the human body is no longer loading the high impedance location of antenna, while maintaining the antenna resonance frequency.

One aspect of the present subject matter provides a method of using an antenna within a handheld wireless communication device. The method includes monitoring antenna performance using information received from a sensor within the device. The device uses information from sensors that monitor performance related parameters to identify environmental changes that can adversely affect the antenna. Types of sensors include, but are not limited to, touch sensors such as capacitive sensors, impedance measuring sensors or circuits, light proximity sensors, capacity proximity sensors, orientation sensors, or some combination thereof. Other types of sensors can be used without departing from the scope of the present subject matter. When a sensed parameter indicative of antenna performance drops below a programmable threshold (for example, when impedance due to a human hand is detected) due to proximity or contact with a user, a signal from a processor is used to actuate a circuit component (such as component at location 358 in FIG. 3) to change a location of a high impedance portion of the antenna to reduce the effects of the proximity or contact with the user, in various embodiments. In one embodiment, using a signal from a processor to actuate a circuit component results in changing a resonant mode of the antenna. In various embodiments, monitoring antenna performance includes measuring antenna impedance by comparing the forward and reverse signal from a transmitter to calculate antenna impedance, using a capacitive sensor to sense human body loading at the antenna high impedance location to determine how antenna performance is affected, using a proximity sensor to sense proximity of a user and deriving the load condition and the resulting change in antenna performance, and/or using an orientation sensor with the proximity sensor to derive antenna performance when held by a user. For example, orientation sensors (such as tilt sensor, accelerometer, and/or magnetometer) can be used to derive the orientation of the device. Together with orientation information, proximity information can be used to derive a use case and thus derive the impedance load to antenna. For example, a change of antenna impedance measured by calculating the reflection coefficient will indicate a load change to antenna, and a large deviation from the matched impedance target (50 ohms typically) will indicate the high impedance point is loaded by human body or other low impedance material (such as the “death grip”). In another example, a change in impedance combined with a change in orientation of the device can indicate the device is being held by a user, thus changing antenna performance.

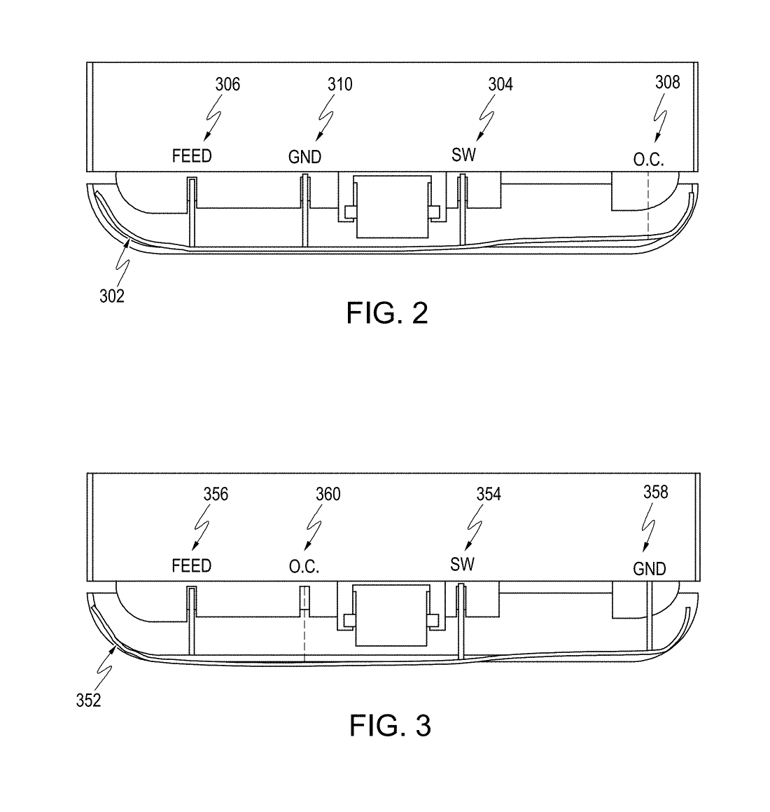

The method includes actuating a second circuit component at a second location (such as location 310 in FIG. 2) away from the first high impedance portion, the second circuit component configured to provide a second current path to move the high impedance portion to the second location, in various embodiments. The circuit component may include a switch and/or a tunable capacitor, in various embodiments. In various embodiments, the switch does not include a capacitor, but connects to a capacitor, an inductor or ground. In various embodiments, the switch includes a capacitor. In further embodiments, the tunable capacitor is configured to function as a switch by changing capacitance to increase or decrease current flow.

Another aspect provides a handheld wireless communication device including a metal housing, an antenna for wireless communication, a sensor configured to sense a parameter indicative of antenna performance, a circuit component within the housing connected to the antenna at or near a high impedance portion of the antenna, and a processor within the housing. The processor is configured to monitor performance of the antenna using information received from the sensor and when antenna performance drops below a programmable threshold due to proximity or contact with a user, the processor actuates the circuit component to change a location of the high impedance portion of the antenna to reduce the effects of the proximity or contact with the user. The circuit component may include a switch and/or a tunable capacitor, in various embodiments. In various embodiments, the antenna includes a cellular antenna, such as a PIFA or a monopole antenna. In various embodiments, the antenna includes a WiFi antenna. The device may further include a second circuit component at a second location away from the high impedance portion, the second circuit component configured to be actuated to provide an open circuit condition to move the high impedance portion to the second location. In various embodiments, the wireless communication device includes a cellular telephone, a tablet, or a handheld global positioning system (GPS) device.

FIGS. 2-3 illustrate a top view of a bottom portion of a mobile communication device including an antenna 302, according to various embodiments. In normal or “free space” configuration shown in FIG. 2, the antenna 302 includes a low band mode that has a monopole configuration. Portions of the antenna 302 include a feed 306, a ground or low impedance location 310 (similar to ground plane 110 in FIG. 1), a switch 304 for tuning the antenna, and an open circuit (OC) or high impedance location 308. In various embodiments, switch 304 connects to a capacitor, an inductor or ground. In FIG. 3, a “hand” configuration is shown, where antenna 352 includes a feed 356, and a switch 354. In FIG. 3, feed 356 is the same type of element as feed 306 and switch 354 is the same type of element as switch 304, in various embodiments. In the configuration of FIG. 3, a user's hand has been detected near location 308, causing a switch to close, or changing of capacitance of tunable capacitor such as DVC 108 in FIG. 1, at or near the location to short the high impedance electrically at the band of interest, transforming it into low impedance location at 358. In further embodiments, a second switch or tunable capacitor at second location 360 will actuate to transform the high impedance point to a second location. Switch 304 (or 354) can also be used to further tune antenna resonant frequency. Thus, when the user's hand electrically shorts the slot or high impedance location, the antenna switches to the hand configuration, by sensing the impedance change caused by the user's hand and then electrically shorting the first high impedance location by closing the switch or increasing capacitance at 308 such as with a computer processor signal to allow the current to flow through the closer path to the ground instead of through the hand, in an embodiment. Also, antenna matching for the hand configuration is optimized to minimize the hand loss in various embodiments. Thus, FIG. 2 shows the original antenna configuration, and FIG. 3 shows the same antenna with the hand configuration to maintain performance when held by a user.

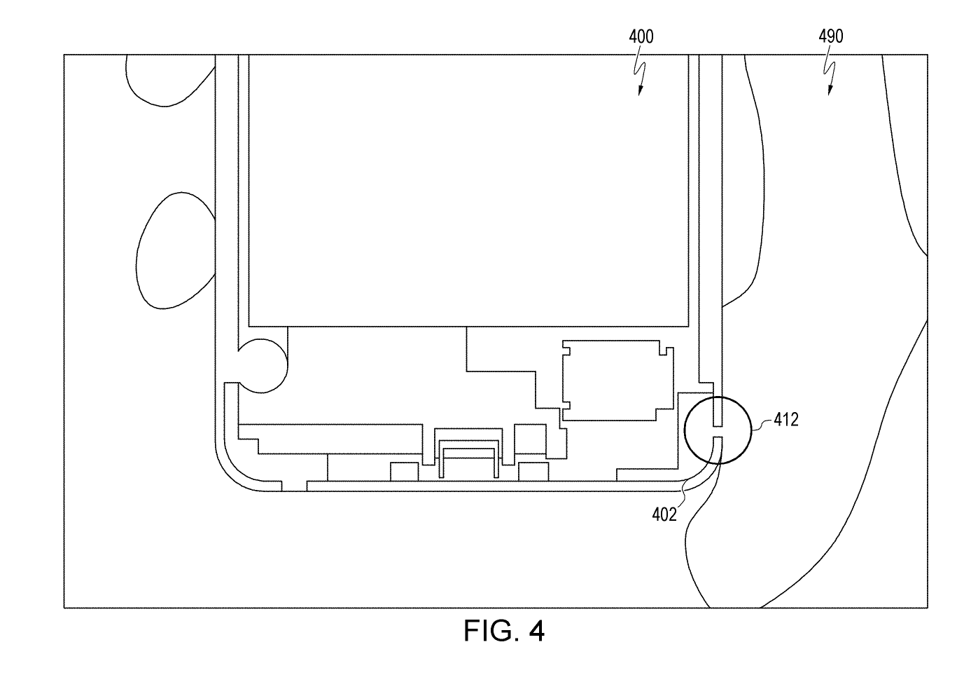

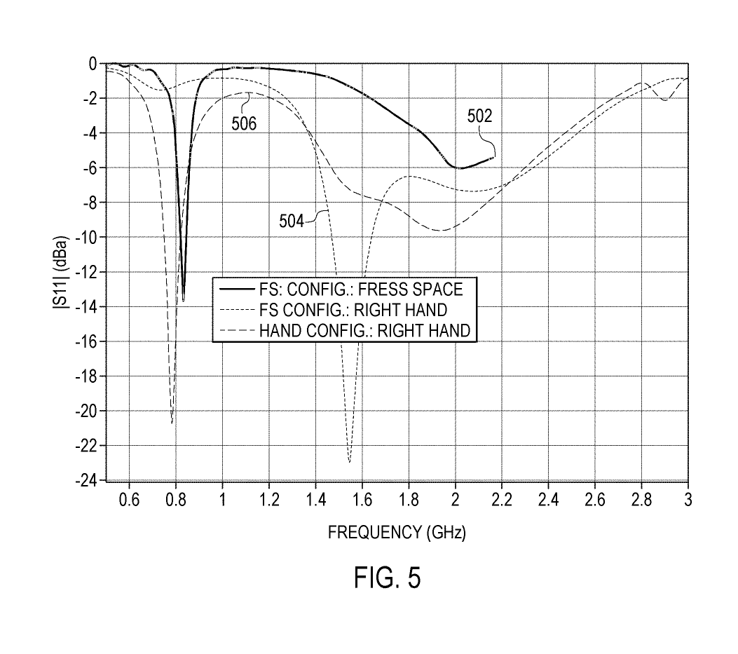

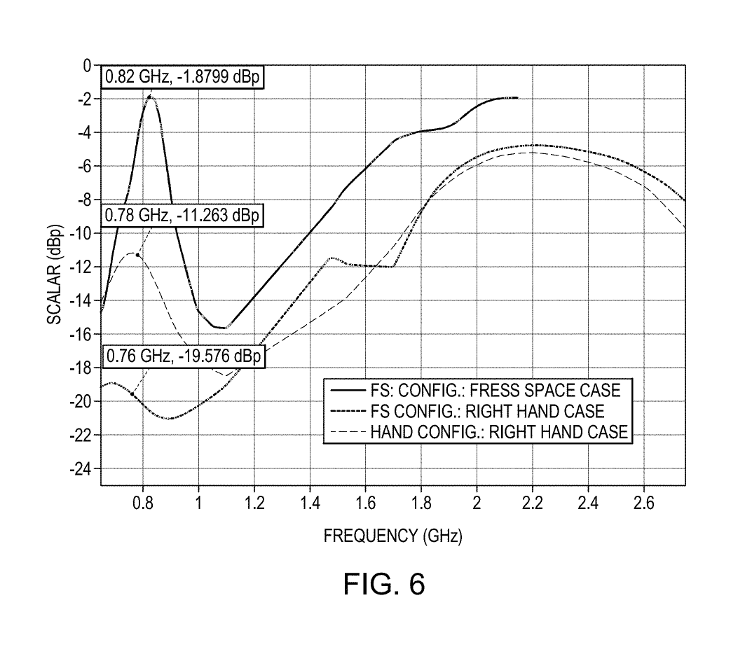

FIG. 4 illustrates a cross section view of a mobile communication device 400 as held by a human hand 490 in proximity to a high impedance location 412 of an antenna 402, according to various embodiments. FIG. 5 is a graph illustrating return loss for an antenna of a mobile communication device, according to various embodiments. The Free Space curve 502 illustrates the return loss when phone in free space (ideal case with no human interface). The Right Hand curve 504 illustrates the return loss when death grip happens; the hand is shorting out the slotted metal back cover as shown in FIG. 4. Thus, the antenna impedance has been detuned significantly especially at low band around 800 MHz. The Hand Configuration curve 506 illustrates the same hand grip but after the high impedance location is switched to the configuration as shown in FIG. 3B, thus the antenna return loss can be tuned back as in the free space case. FIG. 6 is a graph illustrating total efficiency for an antenna of a mobile communication device, according to various embodiments. As shown, when death grip occurs, the total efficiency drop almost 18 dB around 800 MHz from free space case. Using the method of the present subject matter, the total efficiency can improves about 8 dB at lowband in the same hand grip in the depicted embodiment.

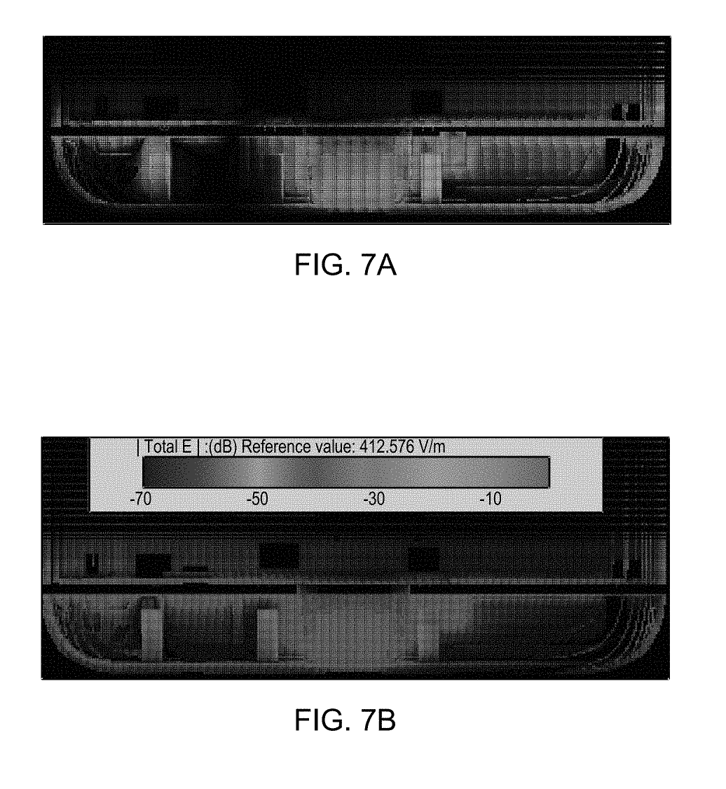

FIGS. 7A-7B illustrate an antenna modal analysis for a mobile communication device, according to various embodiments. As depicted, the method of the present subject matter substantially improves antenna performance for the circumstance in which the user's hand is sensed at the high impedance portion of the antenna.

According to various embodiments, the aperture tunable antenna of the present subject matter is adapted for the hand load condition. The antenna is designed with an open state switch at its high impedance location (such as location 308 in FIG. 2), which is the open end of PIFA or monopole types of antennas. If the high impedance location is loaded with a human body part, the open state switch is changed to close state to bypass the load from human body (such as location 358 in FIG. 3), in various embodiments. In further embodiments, tunable capacitors or switches at other location may be required to bring back the antenna resonance frequency. As a result of this tuning, the antenna resonant mode changes and high impedance location changes to a different part of the antenna, thus reducing the human load effect. Thus, the present subject matter provides for load-adapting control of the aperture tunable antenna. In various embodiments, antenna load change could be characterized by direct onboard impedance measurement. One embodiment of impedance measurement is to extract the forward and reverse component of a transmit signal with a directional coupler, and obtain a reflection coefficient at the directional coupler by comparing the amplitude and phase relation between the forward and reverse signal. The antenna impedance could be obtained by de-embedding a matching network between the directional coupler and antenna. In further embodiments, antenna load change could be derived by sensor measurement, including a capacitance sensor to sense human body loading of particular location, one or more proximity sensors, and/or an orientation sensor used together with proximity sensors. Other methods of detecting antenna load changes can be used without departing from the scope of the present subject matter. The present subject matter provides a method to eliminate the death grip by changing the high impedance location such that human body load is no longer at the high impedance location, thus improving performance for devices with metal slotted cases. Human body includes the death grip case, and position of the body proximate the antenna in various embodiments.

The functions or algorithms described herein may be implemented in software or a combination of software and human implemented procedures in one embodiment. The software may be in the form of computer executable instructions stored on computer readable media or computer readable storage devices such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system. Various embodiments include more than one controller in the wireless network and include distributed processing to perform the present subject matter.

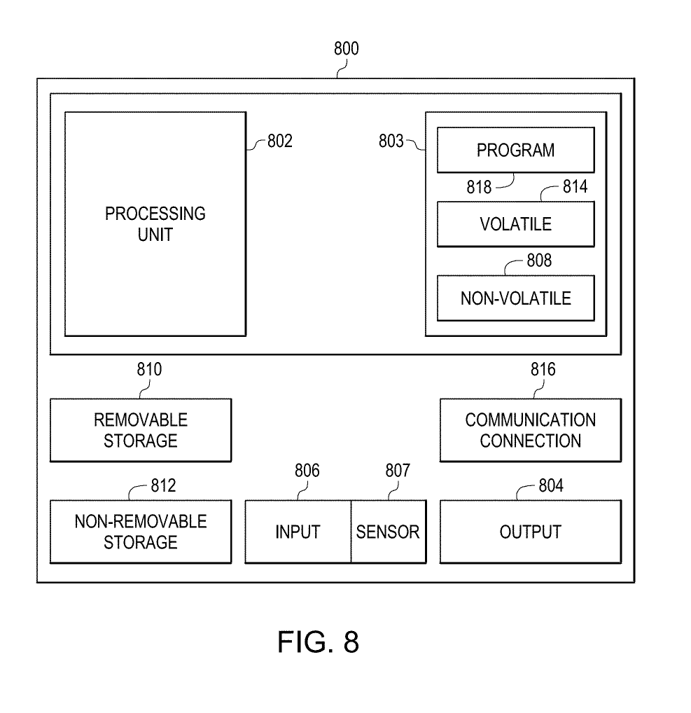

FIG. 8 is a block schematic diagram of a computer system 800 to implement the controller and methods according to example embodiments. All components need not be used in various embodiments. One example computing device in the form of a computer 800 may include a processing unit 802, memory 803, removable storage 810, and non-removable storage 812. Although the example computing device is illustrated and described as computer 800, the computing device may be in different forms in different embodiments. For example, the computing device may instead be a smartphone, a tablet, smartwatch, or other computing device including the same or similar elements as illustrated and described with regard to FIG. 8. Devices such as smartphones, tablets, and smartwatches are generally collectively referred to as mobile devices. Further, although the various data storage elements are illustrated as part of the computer 800, the storage may also or alternatively include cloud-based storage accessible via a network, such as the Internet. Various embodiments include more than one controller in the wireless network and include distributed processing to perform the methods of the present subject matter. For example, each base station in a cellular network may have a controller or controllers that can exchange messages with other controllers and control the network in a distributed fashion.

Memory 803 may include volatile memory 814 and non-volatile memory 808. Computer 800 may include—or have access to a computing environment that includes—a variety of computer-readable media, such as volatile memory 814 and non-volatile memory 808, removable storage 810 and non-removable storage 812. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 800 may include or have access to a computing environment that includes input 806, output 804, and a communication connection 816. In various embodiments, communication connection 816 includes a transceiver and an antenna. Output 804 may include a display device, such as a touchscreen, that also may serve as an input device. The input 806 may include one or more of a touchscreen, touchpad, mouse, keyboard, camera, one or more device-specific buttons, one or more sensors 807 integrated within or coupled via wired or wireless data connections to the computer 800, and other input devices. As stated above, types of sensors 807 include, but are not limited to, touch sensors such as capacitive sensors, impedance measuring sensors or circuits, proximity sensors, orientation sensors, or some combination thereof. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), cellular (3G, 4G, LTE, beyond LTE, 5G, etc.), WiFi, Bluetooth, and other networks.

Computer-readable instructions stored on a computer-readable medium are executable by the processing unit 802 of the computer 800. A hard drive, CD-ROM, and RAM are some examples of articles including a non-transitory computer-readable medium, such as a storage device. The terms computer-readable medium and storage device do not include carrier waves. For example, a computer program 818 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 800 to provide generic access controls in a COM based computer network system having multiple users and servers.

Although some embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A computer readable storage device comprising instructions that, when executed by a computer processor, cause the processor to:
monitor antenna performance of an antenna within a handheld wireless communication device using information received from a sensor within the device; and
when antenna performance drops below a programmable threshold due to proximity or contact with a user, using a signal to actuate a circuit component to change a location of a high impedance portion of the antenna to maintain antenna performance.

2. The computer readable storage device of claim 1, wherein using a signal from a processor to actuate a circuit component includes changing a resonant mode of the antenna.

3. The computer readable storage device of claim 1, wherein monitoring antenna performance includes measuring antenna impedance with a matching network.

4. The computer readable storage device of claim 1, wherein monitoring antenna performance includes using a capacitive sensor to sense human body loading at the location.

5. The computer readable storage device of claim 1, wherein monitoring antenna performance includes using a proximity sensor to sense proximity of a user.

6. The computer readable storage device of claim 5, comprising using an orientation sensor with the proximity sensor to monitor antenna performance.

7. The computer readable storage device of claim 1, further comprising opening a second circuit component at a second location away from the high impedance portion, the second circuit component configured to provide an open circuit condition to move the high impedance portion to the second location.

8. The computer readable storage device of claim 1, wherein the circuit component includes a switch.

9. The computer readable storage device of claim 1, wherein the circuit component includes a tunable capacitor.

10. The computer readable storage device of claim 1, wherein the wireless communication device includes a cellular telephone.

11. A handheld wireless communication device, comprising:
a housing;
an antenna for wireless communication;
a sensor configured to sense a parameter indicative of antenna performance;
a circuit component within the housing connected to the antenna at or near a high impedance portion of the antenna; and
a processor within the housing, the processor configured to:
monitor performance of the antenna using information received from the sensor; and
when antenna performance drops below a programmable threshold, actuate the circuit component to change a location of the high impedance portion of the antenna to reduce the effects of the proximity or contact with the user.

12. The device of claim 11, wherein the circuit component includes a switch.

13. The device of claim 11, wherein the circuit component includes a tunable capacitor.

14. The device of claim 11, wherein the antenna includes a cellular antenna.

15. The device of claim 11, wherein the antenna includes a planar inverted-F antenna (PIFA).

16. The device of claim 11, further comprising a second circuit component at a second location away from the high impedance portion, the second circuit component configured to be actuated to provide an open circuit condition to move the high impedance portion to the second location.

17. A handheld wireless communication device, comprising:
an antenna for wireless communication;
multiple sensors configured to sense a parameter indicative of antenna performance;
a circuit component within the housing connected to the antenna at or near a high impedance portion of the antenna; and
a processor within the housing, the processor configured to:
monitor performance of the antenna using information received from the sensors; and
when antenna performance drops below a programmable threshold, actuate the circuit component to change a location of the high impedance portion of the antenna to reduce the effects of the proximity or contact with the user.

18. The device of claim 17, wherein the wireless communication device includes a cellular telephone.

19. The device of claim 17, wherein the wireless communication device includes a tablet.

20. The device of claim 17, wherein the wireless communication device includes a handheld global positioning system (GPS) device.
